(19) United States
(12) Patent Application Publication
(10) Pub. No.: US 2019/0265148 A1
(43) Pub. Date: Aug. 29, 2019

(54) FLUID SENSOR

(71) Applicant: NGK INSULATORS, LTD., Nagoya-Shi (JP)

(72) Inventors: Keiichi KANNO, Nagoya-Shi (JP); Hidemasa Okumura, Nagoya-Shi (JP); Kazuyuki Mizuno, Nagoya-Shi (JP)

(73) Assignee: NGK INSULATORS, LTD., Nagoya-Shi (JP)

(21) Appl. No.: 16/285,703

(22) Filed: Feb. 26, 2019

(30) Foreign Application Priority Data
Feb. 27, 2018 (JP) 2018-033481

(51) Int. Cl. G01N 15/06

(52) U.S. Cl. CPC G01N 15/0656

(57) ABSTRACT

A fluid sensor may include a sensor head configured to be placed within a fluid passage; an inlet defined in an outer surface of the sensor head and configured to take in fluid into the sensor head; an outlet defined in the outer surface of the sensor head and configured to let out the fluid from the sensor head; a sensing passage extending between the inlet and the outlet within the sensor head; and a sensing unit configured to sense a characteristic of the fluid flowing through the sensing passage. The sensor head may be configured to be placed within the fluid passage such that flow velocity of the fluid along the outer surface of the sensor head is higher at a position of the outlet than at a position of the inlet.

### CROSS-REFERENCE

This application claims priority to Japanese Patent Application No. 2018-033481, filed on Feb. 27, 2018, the entire contents of which are incorporated herein by reference.

### TECHNICAL FIELD

The technique disclosed herein relates to a fluid sensor configured to sense a characteristic of fluid.

### BACKGROUND

Japanese Patent Application Publication No. 2012-194078 describes a fine particle sensor as an example of fluid sensors. This fine particle sensor is configured to detect fine particles contained in exhaust gas and includes a sensor head configured to be placed in an exhaust pipe.

An outer surface of the sensor head is provided with an inlet and an outlet for the exhaust gas, and a sensing passage extending between the inlet and the outlet is provided within the sensor head. In the sensing passage, ions are generated and fine particles contained in the exhaust gas are thereby ionized. Then, the ionized fine particles or excess ions are collected, and an amount of the fine particles contained in the exhaust gas is estimated based on an amount of the collected particles or ions.

### SUMMARY

In a fine particle sensor, exhaust gas, which is a target to be sensed, needs to be introduced into a sensing passage with suitable flow rate. For example, if the exhaust gas that is flowing at high velocity in an exhaust pipe is introduced into the sensing passage with that same velocity, fine particles contained in the exhaust gas cannot be detected accurately. This problem is also common in fluid sensors of other types, such as a NOₓ sensor and an oxygen sensor. For this problem, the aforementioned-conventional fine particle sensor injects compressed air into the sensing passage and introduces exhaust gas into the sensing passage by using a negative pressure resulting from the compressed air flow. With such a configuration, the flow rate of the exhaust gas to be introduced to the sensing passage can be adjusted by adjusting the compressed air that is supplied, however, a pump and a pipe for supplying the compressed air to the fine particle sensor are necessary. The disclosure herein provides a technique capable of introducing fluid, which is a target to be sensed, with suitable flow rate into a sensing passage without compressed air supply in fine particle sensors and other fluid sensors.

In an embodiment of the technique disclosed herein, a fluid sensor configured to sense a characteristic of fluid flowing in a fluid passage is disclosed. This fluid sensor may comprise a sensor head configured to be placed within the fluid passage; an inlet defined in an outer surface of the sensor head and configured to take in the fluid into the sensor head; an outlet defined in the outer surface of the sensor head and configured to let out the fluid from the sensor head; a sensing passage extending between the inlet and the outlet within the sensor head; and a sensing unit configured to sense the characteristic of the fluid flowing through the sensing passage. The sensor head may be configured to be placed within the fluid passage such that flow velocity of the fluid along the outer surface of the sensor head is higher at a position of the outlet than at a position of the inlet.

According to the above configuration, pressure at the outlet is lower than pressure at the inlet. Due to this, a negative pressure gradient is generated from the inlet toward the outlet in the sensing passage, and the fluid, which is a target to be sensed, is thereby introduced to the sensing passage. A flow rate in the sensing passage at this time varies depending on position(s), size(s) and shape(s) of the inlet and/or the outlet. Therefore, by designing those suitably, the fluid to be sensed can be introduced to the sensing passage with suitable flow rate. Since compressed air does not necessarily need to be supplied in this fluid sensor, a pump and a pipe for the supply can be omitted.

### BRIEF DESCRIPTION OF DRAWINGS

FIG. 1 is a perspective view schematically showing a fine particle sensor 10 attached to an exhaust pipe 2.

FIG. 2 is a cross sectional view schematically showing the fine particle sensor 10 attached to the exhaust pipe 2.

FIG. 3 is a perspective view schematically showing a main body 14 and a cover 16 of a sensor head 12.

FIG. 4 is a cross sectional view along a line IV-IV in FIG. 2.

FIG. 5 is a cross sectional view schematically showing a configuration of a sensing unit 30.

FIG. 6 is a graph showing a relationship between a width W of an inlet 20 and a flow velocity of exhaust gas in a sensing section 24a.

FIG. 7 is a cross sectional view showing a cover 116 of a variant.

### DETAILED DESCRIPTION

In an embodiment of the technique disclosed herein, the sensor head may be further configured to be placed within the fluid passage such that the outlet is directed to open in a direction intersecting a flow direction within the fluid passage, especially, in a direction perpendicular to the flow direction within the fluid passage. With such a configuration, a velocity of fluid at a position of an outlet is relatively high, and thus a pressure gradient in a sensing passage can be intensified. Further, the fluid flowing in a fluid passage can be suppressed from counterflowing from the outlet. Due to this, the fluid to be sensed can be stably introduced to the sensing passage.

In an embodiment of the technique disclosed herein, an outer surface of the sensor head may comprise a side face and/or an end face configured to be placed parallel with the flow direction within the fluid passage. In this case, the outlet may be defined in one of or both the side face and the end face. With such a configuration, the outlet is directed to open in the direction intersecting the flow direction within the fluid passage, and thus the fluid to be sensed can be stably introduced to the sensing passage as described above.

In an embodiment of the technique disclosed herein, the sensor head may be further configured to be placed within the fluid passage such that an inlet is directed to open toward downstream of the flow direction within the fluid passage. With such a configuration, a velocity of the fluid at a position of the inlet is relatively low, and thus the pressure gradient in the sensing passage can further be intensified. Further, since the inlet is not directly exposed to the flow within the fluid passage, flow rate of the fluid flowing into the inlet can be suppressed from varying even when a velocity of the fluid flowing in the fluid passage varies. Due to this, the fluid to be sensed can be stably introduced to the sensing passage.

In an embodiment of the technique disclosed herein, the outer surface of the sensor head may comprise a back face configured to be placed toward the downstream of the flow direction within the fluid passage. In this case, the inlet may be defined in the back face. With such a configuration, since the inlet is directed to open toward the downstream of the flow direction within the fluid passage, the fluid to be sensed can be stably introduced to the sensing passage as described above.

In an embodiment of the technique disclosed herein, the sensing passage may comprise a sensing section where a sensing unit is disposed and an outlet section connected to the sensing section and extending to the outlet. In this case, the sensor head may be further configured to be placed within the fluid passage such that the sensing section extends parallel with the flow direction within the fluid passage and the outlet section is directed along a direction intersecting the flow direction within the fluid passage. Usually, the sensing section where the sensing unit is disposed needs to have a certain length. Therefore, a size of the sensor head tends to be large along a longitudinal direction of the sensing section. With the sensing section disposed to extend parallel with the flow direction within the fluid passage, an area where the flow within the fluid passage is blocked by the sensor head can be decreased. Further, with the outlet section that connects the sensing section and the outlet disposed along the direction intersecting the flow direction within the fluid passage, the fluid flowing in the fluid passage can be suppressed from counterflowing from the outlet.

In an embodiment of the technique disclosed herein, the sensor head may be further configured to be placed within the fluid passage such that the outlet section is directed along either a direction perpendicular to the flow direction within the fluid passage or a direction gradually shifting to the downstream of the flow direction toward the outlet. With such a configuration, the fluid flowing in the fluid passage can be effectively suppressed from counterflowing from the outlet.

In an embodiment of the technique disclosed herein, the sensor head may comprise a main body constituted of ceramic and supporting the sensing unit, and a cover constituted of metal and covering the main body. In this case, the inlet and the outlet may be defined in the cover, and the sensing passage may extend through the main body. With such a configuration, various kinds of the sensor head in which the inlet and/or the outlet are provided at various positions can be manufactured by changing only the cover.

In an embodiment of the technique disclosed herein, the sensing unit may be configured to measure an amount of particles contained in the fluid. Here, measuring the amount of particles includes measuring at least one of a number, a mass and a volume of the particles, for example. The technique disclosed herein can be applied to various types of fluid sensors, and the sensing unit may be configured to measure any characteristic of the fluid, not limited to the amount of particles.

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved fluid sensors, as well as methods for using and manufacturing the same.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

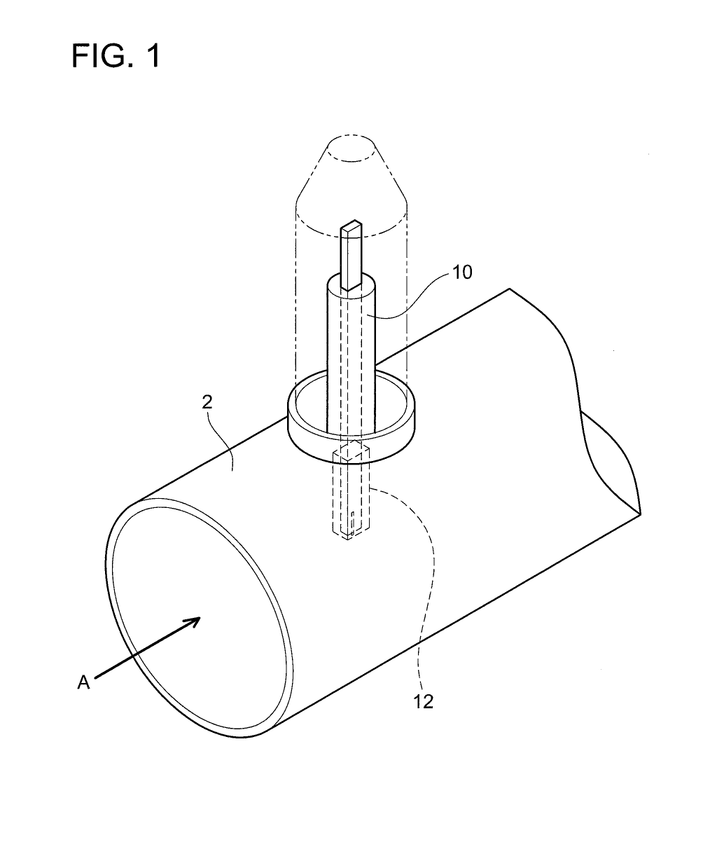

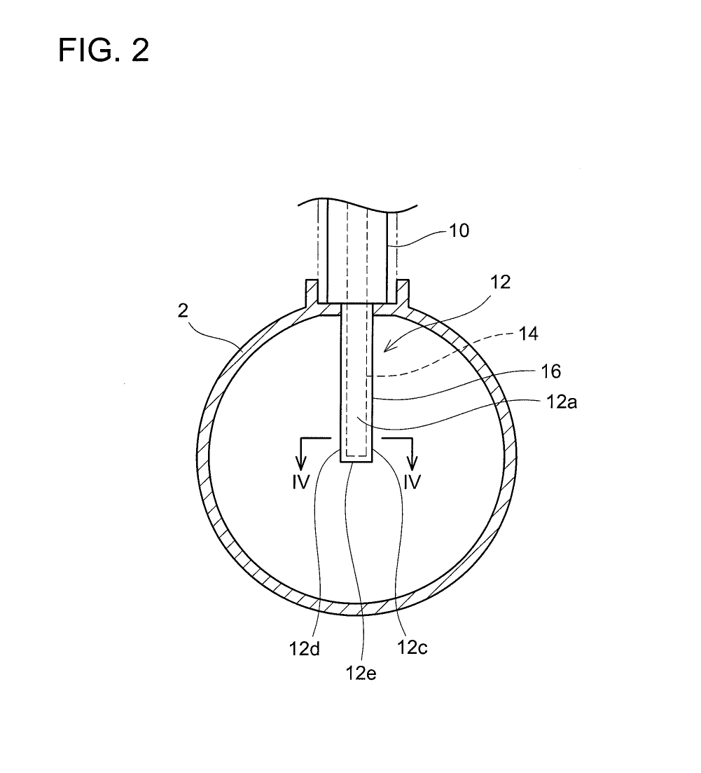

With reference to the drawings, a fine particle sensor 10 of an embodiment will be described. The fine particle sensor 10 of the present embodiment is mounted on, for example, an automobile and is used to monitor a number of fine particles contained in exhaust gas from an engine. As shown in FIGS. 1 and 2, the fine particle sensor 10 includes a sensor head 12. The sensor head 12 is configured to be placed in an exhaust pipe 2 which is a fluid passage of the exhaust gas, and is configured to measure the number of fine particles contained in the exhaust gas flowing in the exhaust pipe 2. Usually, the sensor head 12 is placed vertically with respect to a longitudinal direction of the exhaust pipe 2 (i.e., with respect to a flow A of the exhaust gas within the exhaust pipe 2).

The sensor head 12 has a substantially cuboid shape, and includes a front face 12a, a back face 12b, a left-side face 12c, a right-side face 12d and an end face 12e as its outer surface. The front face 12a and the back face 12b are positioned opposite to each other. The left-side face 12c and the right-side face 12d are positioned opposite to each other, and each of them extends between the front face 12a and the back face 12b. The end face 12e is positioned at a distal end of the sensor head 12, and is adjacent to the front face 12a, the back face 12b, the left-side face 12c and the right-side face 12d. When the sensor head 12 is placed in the exhaust pipe 2, the front face 12a is directed to an upstream of the flow A and the back face 12b is directed to a downstream of the flow A. The left-side face 12c, the right-side face 12d and the end face 12e are arranged to be parallel with the flow A.

Here, a direction connecting the front face 12a and the back face 12b of the sensor head 12 is termed a front-back direction, a direction connecting the left-side face 12c and the right-side face 12d is termed a right-left direction, and a direction vertical to both of the front-back direction and the right-left direction is termed a longitudinal direction. In this case, the front-back direction of the sensor head 12 is parallel with the longitudinal direction of the exhaust pipe 2 (i.e., the flow A within the exhaust pipe 2), and the right-left direction of the sensor head 12 is vertical to the longitudinal direction of the exhaust pipe 2 (i.e., the flow A within the exhaust pipe 2). In the present embodiment, the sensor head 12 has a smaller dimension in the right-left direction than in the front-back direction. Therefore, an area where the flow A in the exhaust pipe 2 is blocked by the sensor head 12 is relatively small. It should be noted that dimensions of the sensor head 12 are not limited to examples disclosed herein and they can be changed variously. Further, each of the front face 12a, the back face 12b, the left-side face 12c, the right-side face 12d and the end face 12e of the sensor head 12 is not limited to a flat face, and may be a curved face such as a concave face or a convex face.

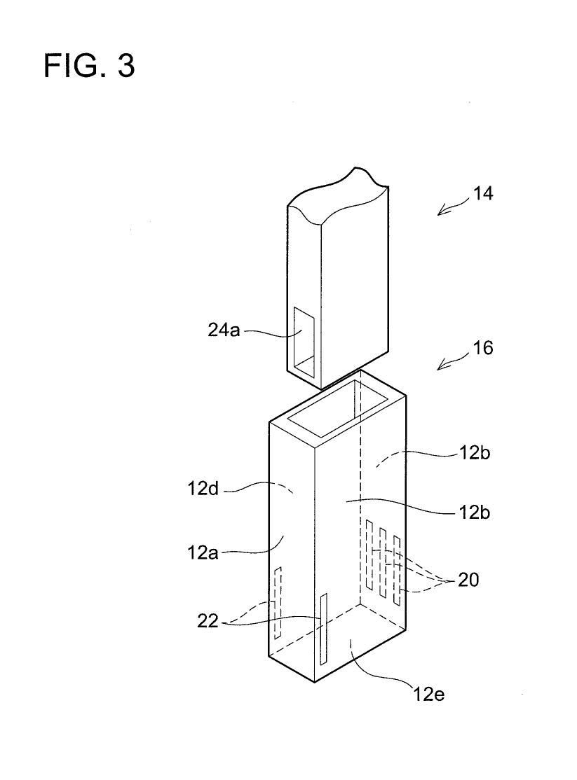

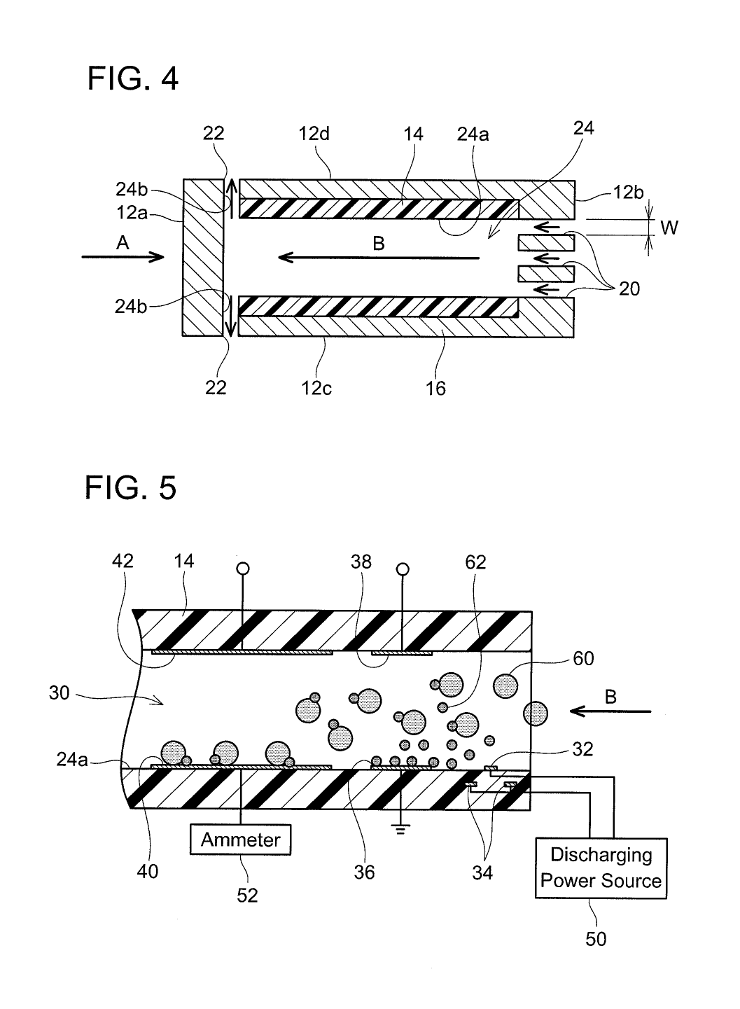

As shown in FIGS. 3 and 4, the sensor head 12 of the present embodiment includes a main body 14 and a cover 16 covering the main body 14. The main body 14 is constituted of ceramic, and the cover 16 is constituted of metal such as stainless steel. Due to the combination of the ceramic main body 14 and the metal cover 16, the sensor head 12 exhibits excellent durability even within the exhaust pipe 2 having a high temperature. In another embodiment, the sensor head 12 may be, for example, a single member constituted of ceramic, instead of the combination of the main body 14 and the cover 16.

The sensor head 12 includes three inlets 20 configured to take in the exhaust gas, two outlets 22 configured to let out the exhaust gas, and a sensing passage 24 extending between the inlets 20 and the outlets 22 within the sensor head 12. The three inlets 20 are defined in the back face 12b of the sensor head 12, and the two outlets 22 are defined respectively in the left-side face 12c and the right-side face 12d of the sensor head 12. Each of the inlets 20 and the outlets 22 has a slit shape extending in the longitudinal direction of the sensor head 12, although this is merely an example. In the sensor head 12 of the present embodiment, the inlets 20 and the outlets 22 are defined in the cover 16, and the sensing passage 24 extends to pass through the main body 14, although no limitation is placed thereto. The sensing passage 24 includes a sensing section 24a provided in the main body 14, and an outlet section 24b extending between the sensing section 24a and the outlets 22 and defined by the cover 16.

When the sensor head 12 is placed within the exhaust pipe 2, velocity of the exhaust gas flowing along the outer surface 12a to 12e of the sensor head 12 is high at the left-side face 12c and the right-side face 12d, and is low at the back face 12b. Due to this flow velocity difference, pressures at the left-side face 12c and the right-side face 12d are lower than pressure at the back face 12b. The fine particle sensor 10 of the present embodiment introduces the exhaust gas into the sensor head 12 by using that pressure difference. As described above, the inlets 20 for the exhaust gas are defined in the back face 12b, and the outlets 22 for the exhaust gas are defined in the left-side face 12c and the right-side face 12d. Therefore, pressure at the outlets 22 is lower than pressure at the inlets 20. Due to this, a negative pressure gradient is generated from the inlets 20 toward the outlets 22 in the sensing passage 24, by which the exhaust gas is introduced into the sensing passage 24. In particular, the pressure difference between the inlets 20 and the outlets 22 is generated regardless of the velocity of the exhaust gas flowing in the exhaust pipe 2. Thus, even if the velocity of the exhaust gas flowing in the exhaust pipe 2 varies, the exhaust gas to be sensed can be stably introduced into the sensing passage 24.

An arrow B in the drawings shows a flow of the exhaust gas in the sensing passage 24. In the present embodiment, in regard to the flow A within the exhaust pipe 2 (see FIG. 1), the inlets 20 are located on a downstream side relative to the outlets 22, although no limitation is placed thereto. Thus, a direction of the flow B of the exhaust gas in the sensing passage 24 is opposite to a direction of the flow A of the exhaust gas in the exhaust pipe 2.

The number and positions of the inlets 20 are not limited to the examples disclosed herein, and can be changed appropriately. That is, the number of the inlets 20 is not limited to three, and may be one, two, or any number larger than three. Further, the positions of the inlets 20 are not limited to the back face 12b of the sensor head 12, and may be changed freely in the outer surface 12a to 12e of the sensor head 12. Similarly, the number of the outlets 22 is not limited to two, and may be one or any number larger than two. The positions of the outlets 22 are also not limited to the left-side face 12c and the right-side face 12d of the sensor head 12, and may be changed freely in the outer surface 12a to 12e of the sensor head 12. In particular, the outlets 22 may be defined in the end face 12e of the sensor head 12 that is parallel with the flow A within the exhaust pipe 2, in addition to or instead of being defined in the left-side face 12c and the right-side face 12d. The inlets 20 and the outlets 22 may be in any arrangement so long as the velocity of fluid flowing along the outer surface 12a to 12e of the sensor head 12 is higher at the positions of the outlets 22 than at the positions of the inlets 20 when the sensor head 12 is placed in the exhaust pipe 2.

As shown in FIG. 5, a sensing unit 30 is provided in the main body 14. The sensing unit 30 is disposed in the sensing section 24a of the sensing passage 24 and is configured to measure a number of fine particles 60 contained in the exhaust gas flowing in the sensing section 24a. The sensing unit 30 of the present embodiment includes a discharge electrode 32, an induction electrode 34, a first collection electrode 36, a first electric-field generating electrode 38, a second collection electrode 40, and a second electric-field generating electrode 42, although this is merely an example. The discharge electrode 32 is provided on an inner surface of the sensing section 24a, and the induction electrode 34 is embedded in the main body 14 near the discharge electrode 32. The discharge electrode 32 and the induction electrode 34 are connected to a discharging power source 50. The discharging power source 50 applies a discharge voltage intermittently (e.g., in a pulse train) between the discharge electrode 32 and the induction electrode 34. Due to this, ions 62 are generated in the sensing section 24a, and the fine particles 60 are ionized due to the ions 62 adhering to the fine particles 60. At this time, a number of the ions 62 adhering to each of the fine particles 60 is substantially constant (e.g., one ion 62 adheres to one fine particle 60).

The first collection electrode 36 and the first electric-field generating electrode 38 are provided on the inner surface of the sensing section 24a on a downstream side of the flow B relative to the discharge electrode 32. The first collection electrode 36 and the first electric-field generating electrode 38 face each other. The first collection electrode 36 and the first electric-field generating electrode 38 are connected to a direct-current power source (not shown), and an electric field is generated therebetween. Since this electric field is relatively weak, only excess ions 62 that are not adhering to the fine particles 60 are attracted to the first collection electrode 36 and collected by the first collection electrode 36. Since the ionized fine particles 60 (i.e., the fine particles 60 with the ions 62) each have a larger mass than the ions 62, they are not collected by the first collection electrode 36 and pass through between the first collection electrode 36 and the first electric-field generating electrode 38.

The second collection electrode 40 and the second electric-field generating electrode 42 are provided on the inner surface of the sensing section 24a on the downstream side of the flow B relative to the first collection electrode 36 and the first electric-field generating electrode 38. The second collection electrode 40 and the second electric-field generating electrode 42 face each other. The second collection electrode 40 and the second electric-field generating electrode 42 are connected to a direct-current power source (not shown), and an electric field is generated therebetween. The electric field generated between the second collection electrode 40 and the second electric-field generating electrode 42 is stronger than the electric field generated between the first collection electrode 36 and the first electric-field generating electrode 38. Therefore, the ionized fine particles 60 are attracted to the second collection electrode 40 and collected by the second collection electrode 40. The second collection electrode 40 is connected to, for example, an ammeter 52. A measured value of the ammeter 52 corresponds to a number of the fine particles 60 collected by the second collection electrode 40 per unit time. Thus, the number or density of the fine particles 60 contained in the exhaust gas can be measured based on the measured value of the ammeter 52 and other index (e.g., flow rate of the exhaust gas flowing in the sensing section 24a).

The above configuration of the sensing unit 30 is merely an example, and it may be changed appropriately. For example, the number of excess ions 62 collected by the first collection electrode 36 is negatively correlated with the number of ionized fine particles 60 collected by the second collection electrode 40. That is, the larger the number of the fine particles 60 in the exhaust gas is, the smaller the number of excess ions 62 collected by the first collection electrode 36 and the larger the number of ionized fine particles 60 collected by the second collection electrode 40. Considering this, in another embodiment, the ammeter 52 may be connected to the first collection electrode 36 to measure the number of excess ions 62, and the number of the fine particles 60 may be estimated based on that measured value. With such a configuration, the second collection electrode 40 and the second electric-field generating electrode 42 are not necessarily needed, and they can be omitted.

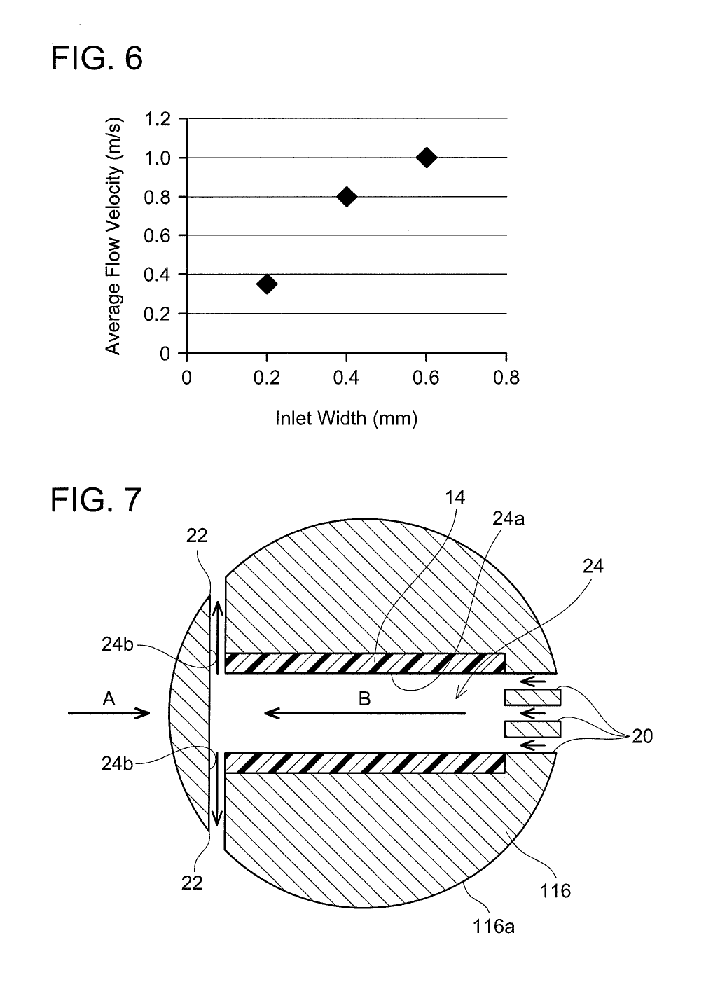

The flow velocity of the exhaust gas in the sensing passage 24 (especially, in the sensing section 24a) varies depending on the positions, numbers, shapes, dimensions and areas of the inlets 20 and the outlets 22. For example, FIG. 6 shows a relationship between a width W of each inlet 20 and the flow velocity of the exhaust gas in the sensing section 24a. As shown in FIG. 6, it has been confirmed that the larger the width W of each inlet 20 becomes, the higher the flow velocity of the exhaust gas becomes when the width W of each inlet 20 is changed in a range of 0.2 mm, 0.4 mm, and 0.6 mm. Considering this, at least in the limited range, it is expected that the flow velocity of the exhaust gas can be made higher with a larger area of the inlets 20. It should be noted that the specific numerical values mentioned herein are merely examples, and they do not place any limitation to the technique disclosed herein.

In the fine particle sensor 10 of the present embodiment, the outlets 22 are directed to open in a direction perpendicular to the flow A within the exhaust pipe 2 when the sensor head 12 is placed in the exhaust pipe 2. With such a configuration, the velocity of the exhaust gas at the positions of the outlets 22 is relatively high, and thus the pressure gradient in the sensing passage 24 can be further intensified. Further, the exhaust gas flowing in the exhaust pipe 2 can be suppressed from counterflowing from the outlets 22. The outlets 22 may not necessarily open in the direction perpendicular to the flow A in the exhaust pipe 2, and it may be directed to open in a direction intersecting the flow A (e.g., in a direction angled at 45 degrees or 60 degrees with respect to the flow A). With such a configuration as well, some of the same effects can be obtained.

In the fine particle sensor 10 of the present embodiment, the inlets 20 are directed to open toward the downstream of the flow A within the exhaust pipe 2 when the sensor head 12 is placed in the exhaust pipe 2. With such a configuration, the velocity of the exhaust gas is relatively low at the positions of the inlets 20, and thus the pressure gradient in the sensing passage 24 can be further intensified. Further, the inlets 20 are not directly exposed to the flow A in the exhaust pipe 2 and thus even if the velocity of the exhaust gas flowing in the exhaust pipe 2 varies, the flow rate to flow into the inlets 20 can be suppressed from varying. Due to this, the exhaust gas to be sensed can be introduced into the sensing passage 24 more stably.

In the fine particle sensor 10 of the present embodiment, the sensing passage 24 includes the sensing section 24a where the sensing unit 30 is disposed and the outlet section 24b extending between the sensing section 24a and the outlets 22. When the sensor head 12 is placed in the exhaust pipe 2, the sensing section 24a extends parallel with the flow A within the exhaust pipe 2 and the outlet section 24b is directed along the direction intersecting the flow A within the exhaust pipe 2. Usually, the sensing section 24a where the sensing unit 30 is disposed needs to have a certain length. Due to this, a size of the sensor head 12 tends to be large along a longitudinal direction of the sensing section 24a. Therefore, when the sensing section 24a is disposed to extend parallel with the flow A within the exhaust pipe 2, an area where the flow A in the exhaust pipe 2 is blocked by the sensor head 12 can be decreased. Further, when the outlet section 24b connecting the sensing section 24a and the outlets 22 is disposed to be directed along the direction intersecting the flow A on the exhaust pipe 2, the exhaust gas flowing in the exhaust pipe 2 can be suppressed from counterflowing from the outlets 22.

In the fine particle sensor 10 of the present embodiment, the outlet section 24b is disposed to be directed especially along the direction perpendicular to the flow A within the exhaust pipe 2 when the sensor head 12 is placed in the exhaust pipe 2. Due to this, the exhaust gas flowing in the exhaust pipe 2 can be efficiently suppressed from counterflowing from the outlets 22. In this respect, in another embodiment, the outlet section 24b may be disposed to be directed along a direction gradually shifting to the downstream of the flow A within the exhaust pipe 2 toward the outlets 22. With such a configuration, the exhaust gas can be more efficiently suppressed from counterflowing into the outlets 22.

In the fine particle sensor 10 of the present embodiment, the sensor head 12 includes the main body 14 constituted of ceramic and supporting the sensing unit 30, and the cover 16 constituted of metal and covering the main body 14. With such a configuration, various kinds of the sensor head 12 in which the inlets 20 and/or the outlets 22 are provided at various positions can be manufactured by changing only the cover 16 while using the same main body 14. Especially, since metal is easily formed in various shapes, the inlets 20 and/or the outlets 22 can be designed relatively freely.

FIG. 7 shows a cover 116 of a variant. This cover 116 differs from the cover 16 described above in having a circular cross section. Other features are common in the covers 16 and 116, and thus explanation thereof will be omitted. With the cover 116 as well, the sensor head 12 is placed in the exhaust pipe 2 such that the velocity of the exhaust gas flowing along the outer surface of the sensor head 12 (i.e., along an outer surface 116a of the cover 116) is higher at the positions of the outlets 22 than at the position of the inlets 20. Specifically, the inlets 20 are directed to open toward the downstream of the flow A within the exhaust pipe 2, and the outlets 22 are directed to open in the direction intersecting the flow A within the exhaust pipe 2. Further, the sensing section 24a of the sensing passage 24 is disposed to extend parallel with the flow A within the exhaust pipe 2, and the outlet section 24b is disposed to be directed along the direction intersecting the flow A within the exhaust pipe 2.

What is claimed is:

1. A fluid sensor configured to sense a characteristic of fluid flowing in a fluid passage, the fluid sensor comprising:
a sensor head configured to be placed within the fluid passage;
an inlet defined in an outer surface of the sensor head and configured to take in the fluid into the sensor head;
an outlet defined in the outer surface of the sensor head and configured to let out the fluid from the sensor head;
a sensing passage extending between the inlet and the outlet within the sensor head; and
a sensing unit configured to sense the characteristic of the fluid flowing through the sensing passage,
wherein
the sensor head is configured to be placed within the fluid passage such that flow velocity of the fluid along the outer surface of the sensor head is higher at a position of the outlet than at a position of the inlet.

2. The fluid sensor according to claim 1, wherein the sensor head is further configured to be placed within the fluid passage such that the outlet is directed to open in a direction intersecting a flow direction within the fluid passage.

3. The fluid sensor according to claim 1, wherein the sensor head is further configured to be placed within the fluid passage such that the outlet is directed to open in a direction perpendicular to a flow direction within the fluid passage.

4. The fluid sensor according to claim 1, wherein
the outer surface of the sensor head comprises a side face and/or an end face configured to be placed parallel with a flow direction within the fluid passage, and
the outlet is defined in one of or both the side face and the end face.

5. The fluid sensor according to claim 1, wherein the sensor head is further configured to be placed within the fluid passage such that the inlet is directed to open toward downstream of a flow direction within the fluid passage.

6. The fluid sensor according to claim 5, wherein
the outer surface of the sensor head comprises a back face configured to be placed toward the downstream of the flow direction within the fluid passage, and
the inlet is defined in the back face.

7. The fluid sensor according to claim 1, wherein
the sensing passage comprises a sensing section where the sensing unit is disposed and an outlet section connected to the sensing section and extending to the outlet,
the sensor head is further configured to be placed within the fluid passage such that the sensing section extends parallel with a flow direction within the fluid passage and the outlet section is directed along a direction intersecting the flow direction within the fluid passage.

8. The fluid sensor according to claim 7, wherein the sensor head is further configured to be placed within the fluid passage such that the outlet section is directed along either a direction perpendicular to the flow direction within the fluid passage or a direction gradually shifting to downstream of the flow direction toward the outlet.

9. The fluid sensor according to claim 1, wherein
the sensor head comprises a main body constituted of ceramic and supporting the sensing unit, and a cover constituted of metal and covering the main body,
the inlet and the outlet are defined in the cover, and
the sensing passage extends through the main body.

10. The fluid sensor according to claim 1, wherein the sensing unit is configured to measure an amount of particles contained in the fluid.

11. The fluid sensor according to claim 1, wherein
the outer surface of the sensor head comprises a side face and a back face adjacent to the side face,
the inlet is defined in the back face, and
the outlet is defined in the side face.

12. The fluid sensor according to claim 11, wherein the side face of the sensor head is perpendicular to the back face of the sensor head.

13. The fluid sensor according to claim 12, wherein
the sensing passage comprises a sensing section where the sensing unit is disposed, and
the sensing section extends along a direction which is perpendicular to the back face of the sensor head.

14. The fluid sensor according to claim 13, wherein
the direction along which the sensing section extends is parallel with the side face of the sensor head.

15. The fluid sensor according to claim 14, wherein
the sensing passage further comprises an outlet section connected to the sensing section and extending to the outlet,
the outlet section is directed along a direction which is perpendicular to the side face of the sensor head.

16. A fluid sensor configured to sense a characteristic of fluid flowing in a fluid passage, the fluid sensor comprising:
a sensor head configured to be placed within the fluid passage;
an inlet defined in an outer surface of the sensor head and configured to take in the fluid into the sensor head;
an outlet defined in the outer surface of the sensor head and configured to let out the fluid from the sensor head;
a sensing passage extending between the inlet and the outlet within the sensor head; and
a sensing unit configured to sense the characteristic of the fluid flowing through the sensing passage,
wherein
the outer surface of the sensor head comprises a side face and a back face adjacent to the side face,
the inlet is defined in the back face, and
the outlet is defined in the side face.

17. The fluid sensor according to claim 16, wherein the side face of the sensor head is perpendicular to the hack face of the sensor head.

18. The fluid sensor according to claim 17, wherein
the sensing passage comprises a sensing section where the sensing unit is disposed, and
the sensing section extends along a direction which is perpendicular to the back face of the sensor head.

19. The fluid sensor according to claim 18, wherein
the direction along which the sensing section extends is parallel with the side face of the sensor head.

20. The fluid sensor according to claim 19, wherein
the sensing passage further comprises an outlet section connected to the sensing section and extending to the outlet, and
the outlet section is directed along a direction which is perpendicular to the side face of the sensor head.
